(19) United States
(12) Patent Application Publication
(10) Pub. No.: US 2012/0110307 A1
(43) Pub. Date: May 3, 2012

(54) COMPRESSED INSTRUCTION PROCESSING DEVICE AND COMPRESSED INSTRUCTION GENERATION DEVICE

(75) Inventor: Masayuki TSUJI, Yokohama (JP)

(73) Assignee: FUJITSU SEMICONDUCTOR LIMITED, Yokohama-shi (JP)

(21) Appl. No.: 13/209,843

(22) Filed: Aug. 15, 2011

(30) Foreign Application Priority Data
Nov. 1, 2010 (JP) 2010-245588

(51) Int. Cl. G06F 9/30

(52) U.S. Cl. 712/210; 712/220; 712/E09.016; 712/E09.028

(57) ABSTRACT

A compressed instruction processing device has: a compressed instruction expanding circuit which expands a compressed instruction code that include a difference code between an instruction code being a compression object and a reference instruction code and which outputs an expanded instruction code; an instruction buffer storing the instruction code expanded by the compressed instruction expanding circuit; and an execution section executing the instruction code expanded by the compressed instruction expanding circuit, wherein the compressed instruction expanding circuit outputs the expanded instruction code by inputting the instruction code in the instruction buffer as the reference instruction code and adding the reference instruction code and the difference code in the compressed instruction code.

### CROSS-REFERENCE TO RELATED APPLICATION

This application is based upon and claims the benefit of priority of the prior Japanese Patent Application No. 2010-245588, filed on Nov. 1, 2010, the entire contents of which are incorporated herein by reference.

### FIELD

The embodiments discussed herein are directed to a compressed instruction processing device and a compressed instruction generation device.

### BACKGROUND

In order for a reduction of a program memory capacity and for a decrease of bus access due to fetching of a program, numerous approaches are being taken in which a program a CPU executes is code-compressed to be stored in a memory and the CPU dynamically extracts (expands) the compressed program at a time of instruction execution. As methods of compressing a program, generally, there are one which uses a statistic method and one which uses a dictionary method. The former includes a method such as using a Huffman code to compress by a cache line unit while the latter includes a method such as replacing a plurality of instructions with one instruction.

The method using the statistic method has advantages such that decompression of each line can be independently done since bit data is dealt with by a cache line unit and that a CPU does not have to mind code compression since a fixed-length code is extracted in a cache, but on the other hand, has disadvantages such that it takes a longer time to decode a variable-length code than in the dictionary method and that an index table for address conversion is necessary since a variable-length code is stored in a memory regardless of the fixed-length cache line. With regard to the dictionary method, largeness of the number of instructions registered in a dictionary table is disadvantageous.

Further, there is known an instruction supplying device in a microprocessor, the instruction supplying device having a storage unit to hold an instruction constituting a program being a processing object of a microprocessor, wherein the storage unit is capable of holding a compressed instruction made by multiplexing instructions of a plurality of steps into one instruction by using an index corresponding to each instruction, and further having an instruction correspondence table indicating a relationship between each index of the compressed instruction and an original extracted instruction and a means in which expanding from the index to the extracted instruction is performed by using the instruction correspondence table when the compressed instruction is obtained from the storage unit and in which stop control of a power supply to the storage unit is performed during a processing of the compressed instruction (for example, see Patent Document 1).
[patent Document 1] Japanese Laid-open Patent Publication No. 2001-142696

In expanding the compressed instruction, a circuit scale becomes large if the dictionary table or the instruction correspondence table is used.

### SUMMARY

A compressed instruction processing device has: a compressed instruction expanding circuit which expands a compressed instruction code that include a difference code between an instruction code being a compression object and a reference instruction code and which outputs an expanded instruction code; an instruction buffer storing the instruction code expanded by the compressed instruction expanding circuit; and an execution section executing the instruction code expanded by the compressed instruction expanding circuit, wherein the compressed instruction expanding circuit outputs the expanded instruction code by inputting the instruction code in the instruction buffer as the reference instruction code and adding the reference instruction code and the difference code in the compressed instruction code.

Further, a compressed instruction generation device has: an instruction FIFO to store an instruction code; a selection part which sequentially stores an instruction code being a compression object in the instruction FIFO and selects one of the instruction codes in the instruction FIFO as a reference instruction code in order to compress the instruction code being the compression object; and a generation part generating a compressed instruction code which includes information of a difference between the instruction code being the compression object and the reference instruction code selected by the selection part.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a constitutional example of a compressed instruction processing device according to a first embodiment;

FIG. 2 is a diagram illustrating a constitutional example of a compressed instruction processing device according to a second embodiment;

FIG. 3A to FIG. 3G are tables for explaining a method of generating a compressed instruction code;

FIG. 4A to FIG. 4C are tables representing a concrete method of generating the compressed instruction code of FIG. 3G;

FIG. 5 is a diagram illustrating a constitutional example of a compressed instruction expanding circuit;

FIG. 6 is a diagram illustrating a hardware constitutional example of a compressed instruction generation device according to a third embodiment;

FIG. 7 is a flowchart illustrating a method of generating a compressed instruction code by a compressed instruction generation device; and

FIG. 8 is a flowchart illustrating a processing of an instruction compression processing section.

### DESCRIPTION OF EMBODIMENTS

### First Embodiment

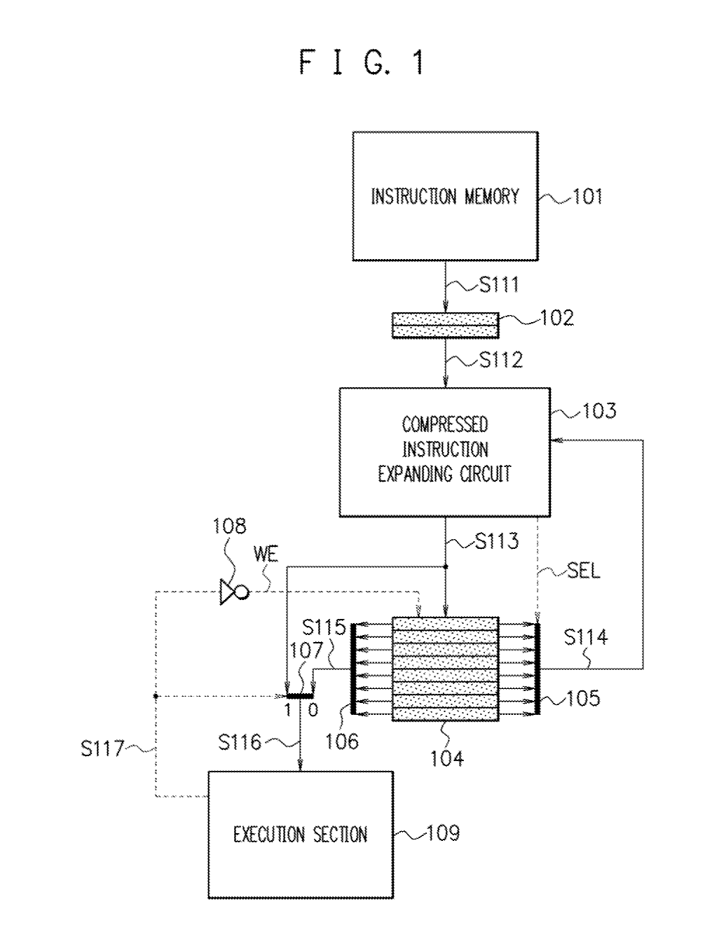

FIG. 1 is a diagram illustrating a constitutional example of a compressed instruction processing device according to a first embodiment. The compressed instruction processing device has an instruction memory 101, a first instruction buffer 102, a compressed instruction expanding circuit 103, a second instruction buffer 104, selectors 105 to 107, an inverter 108, and an execution section 109. The instruction memory 101 is, for example, an instruction cache memory and stores a compressed instruction code. The first instruction buffer 102 buffers a compressed instruction code S111 having been read out from the instruction memory 101 and outputs a compressed instruction code S112. The compressed instruction expanding circuit 103 expands the compressed instruction code S112 and outputs an expanded instruction code S113. When a write enable signal WE becomes “1”, the instruction code S113 is written into the second instruction buffer 104. The second instruction buffer 104 buffers the instruction code S113 and outputs an instruction code S115 via the selector 106. The selector 107, selecting the instruction code S113 when an asynchronous handling signal S117 is “1” and selecting the instruction code S115 when the asynchronous handling signal S117 is “0”, outputs an instruction code S116. The execution section 109 executes the instruction code S116, and makes the asynchronous handling signal S117 be “1” when an instruction code to be executed next is of an asynchronous handling, and makes the asynchronous handling signal S117 be “0” when the instruction code to be executed next is of a synchronous handling.

The asynchronous handlings are formed of codes of instructions generated asynchronously, and are, for example, an interrupt handling, a trap handling, an exception handling, a conditional branch handling and the like. The synchronous handlings are normal handlings other than the asynchronous handling, and are instructions sequentially executed. The inverter 108 performs logical inversion on the asynchronous handling signal S117 and outputs the write enable signal WE. The compressed signal expanding circuit 103 outputs a selection signal SEL in correspondence with the compressed instruction code S112. The selector 105 selects the instruction code in the second instruction buffer 104 in correspondence with the selection signal SEL and outputs the instruction code S114 to the compressed instruction expanding circuit 103. The compressed instruction expanding circuit 103 refers to the instruction code S114 and expands the compressed instruction code S112.

The compressed instruction code S111 is generated by taking a difference between an instruction code being a compression object and the instruction code S114 to be referred to. In the present embodiment, the compressed instruction code S111 is generated by a difference between the preceding instruction code S114 stored in the second instruction buffer 104 and the instruction code being the compression object.

The second instruction buffer 104 has a plurality of entries to store a plurality of instruction codes S113. For example, when the second instruction buffer 104 has 8 entries, 8 or less instructions which are executed before an instruction desired to be compressed are stocked in the second instruction buffer 104. Then, in a next cycle after the instruction desired to be compressed is stored in the first instruction buffer 102, the compressed instruction expanding circuit 103 refers to the selected instruction code S114 in the second instruction buffer 104, expands the compressed instruction code S112, and outputs the expanded instruction code S113.

When the interrupt handling, the trap handling, the exception handling or the like which occurs asynchronously occurs, a program sequence transits to an interrupt handler. In such a case, the asynchronous handling signal S117 becomes “1”, a content of the second instruction buffer 104 is held, and the selector 107 selects the instruction code S113 and directly supplies the instruction code S113 to the execution section 109.

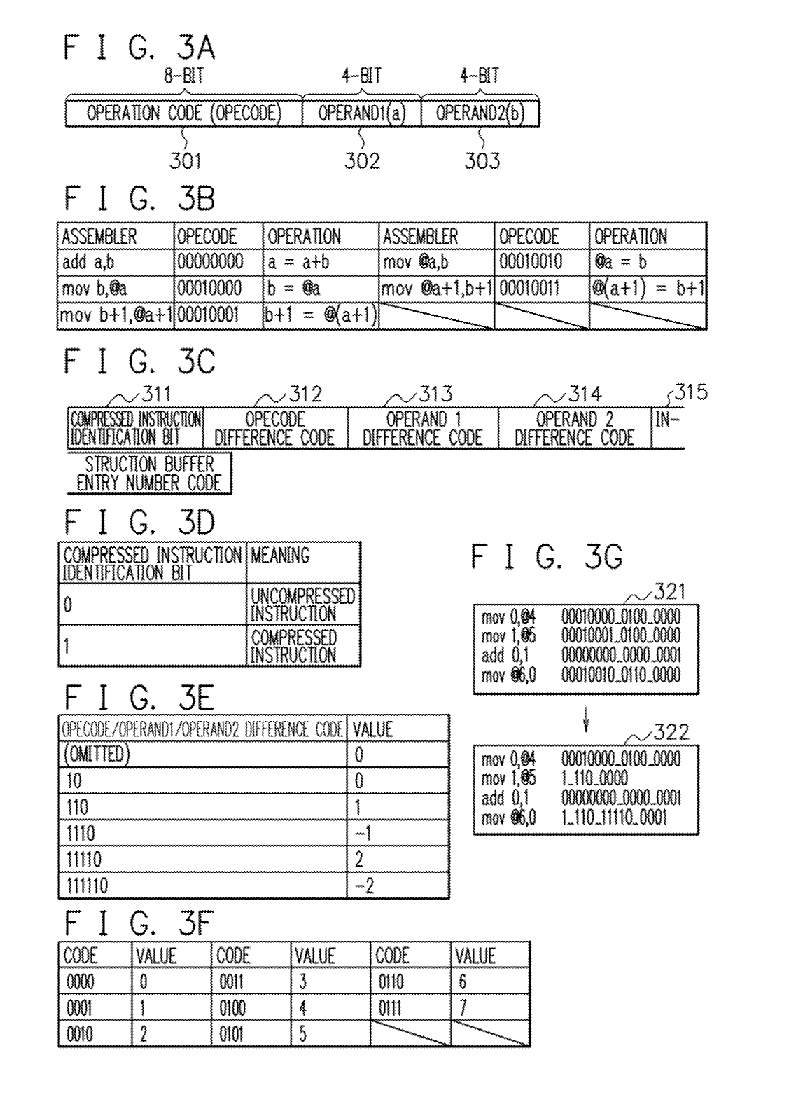

FIG. 3A to FIG. 3G are tables for explaining a method of generating the compressed instruction code S111. By compressing an uncompressed instruction code of FIG. 3A, a compressed instruction code of FIG. 3C is generated.

FIG. 3A represents a format example of the uncompressed instruction code (instruction code being a compression object). The uncompressed instruction code has three fields of, for example, an 8-bit operation code (opecode) 301, a 4-bit first operand 302 and a 4-bit second operand 303.

FIG. 3B represents an assembler, the opecode 301, and an operation, of the instruction code. Here, an instruction code of a synchronous handling is presented. For example, in a case of an assembler of “add a, b” an opecode 301 is “add”, a first operand is “a” and a second operand 303 is “b”. The opecode 301 of “add” is represented by “00000000”, and a computation of “a=b+c” is performed as an operation.

FIG. 3C is a table representing a format example of the compressed instruction code S111. The compressed instruction code S111 has a compressed instruction identification bit (compressed instruction identification information) 311, an opecode difference code 312, a first operand difference code 313, a second operand difference code 314, and an instruction buffer entry number code 315. The opecode difference code 312, the first operand difference code 313, and the second operand difference code 314 are sometimes omitted.

FIG. 3D is a table for explaining the compressed instruction identification bit 311. With regard to the compressed instruction identification bit 311, 0 indicates being an uncompressed instruction code and 1 indicates being a compressed instruction code. “1” of the compressed instruction identification bit 311 is compressed instruction identification information indicating that the instruction code is compressed.

FIG. 3E is a table for explaining the opecode difference code 312, the first operand difference code 313, and the second operand difference code 314. The opecode difference code 312, the first operand difference code 313, and the second operand difference code 314 are difference codes (difference information) per the fields of the instruction code being the compression object, and indicate differences in the opecodes 301, in the first operands 302, and in the second operands 303, between the instruction code being the compression object and the reference instruction code S114. The difference codes 312 to 314 indicate difference codes at times that difference values are each 0, 1, −1, 2, −2, and can be omitted when the difference value is 0. In the difference codes 312 to 314, the final bits are 0, and thus it is possible to identify endings of the respective fields.

FIG. 3F is a table for explaining the instruction buffer entry number code 315. The second instruction buffer 104 has, for example, 8 entries, and the numbers of 8 entries are represented by 0 to 7. For the instruction being the compression object, the instruction code which is the nearest to the instruction code being the compression object in the second instruction buffer 104 can be selected as the reference instruction code S114. The number of the entry in the second instruction buffer 104 where the reference instruction code S114 is stored becomes the instruction buffer entry number code 315.

FIG. 3G is a table representing an example of the instruction code (uncompressed instruction code) 321 before compression and the compressed instruction code 322 after compression. For a first instruction code “mov 0, @4”, the second instruction buffer 104 being empty, the instruction code 321 before compression is made, without compression, to be the instruction code 322 after compression. In this case, since being uncompressed, the compressed instruction identification bit 311 of the head of the instruction code 322 is 0. In other words, “1” of the compressed instruction identification bit 311 indicating that the instruction code is compressed does not exist.

A second instruction code “mov 1, @5” is compressed, with the first instruction code “mov 0, @4” in the second instruction buffer 104 being used as the reference instruction code S114. In this case, since compression is performed, the compressed instruction identification bit 311 becomes “1”. In other words, “1” of the compressed instruction identification bit 311 indicating that the instruction code is compressed exists. Since the opecode 301 of the instruction code “mov 1, @5” being the compression object is “00010001” and the opecode 301 of the reference instruction code “mov 0, @4” is “00010000”, the opecode difference code 312 becomes “110” due to a difference value of 1 therebetween. Further, the first operand 302 of the instruction code “mov 1, @5” being the compression object is “0100” and the first operand 302 of the reference instruction code “mov 0, @4” is “0100”, and thus the first operand difference code 313 is omitted since a difference value therebetween is 0. Further, the second operand 303 of the instruction code “mov 1, @5” being the compression object is “0000” and the second operand 303 of the reference instruction code “mov 0, @4” is “0000”, and thus the second operand difference code 314 is omitted since a difference value therebetween is 0. Further, the reference instruction code “mov 0, @4” is stored in the entry number=0 in the second instruction buffer 104, and thus the instruction buffer entry number code 315 becomes “0000”.

Similarly, for a third instruction code “add 0, 1”, a similar instruction code not existing in the second instruction buffer 104, the instruction code 321 before compression is made, without compression, to be the instruction code 322 after compression. In this case, since being uncompressed, the compressed instruction identification bit 311 of the head of the instruction code 322 becomes 0.

Similarly, a fourth instruction code “mov @6, 0” is compressed, with the second instruction code “mov 1, @5” in the second instruction buffer 104 being used as the reference instruction code S114. In this case, since compression is performed, the compressed instruction identification bit 311 becomes “1”.

The opecode difference code 312 becomes “110” since a difference value therebetween is 1. The first operand difference code 313 becomes “11110” since a difference value therebetween is 2. The second operand difference code 314 is omitted since a difference value therebetween is 0. Further, since the reference instruction code “mov 1, @5” is stored in an entry number=1 in the second instruction buffer 104, the instruction buffer entry number code 315 becomes “0001”.

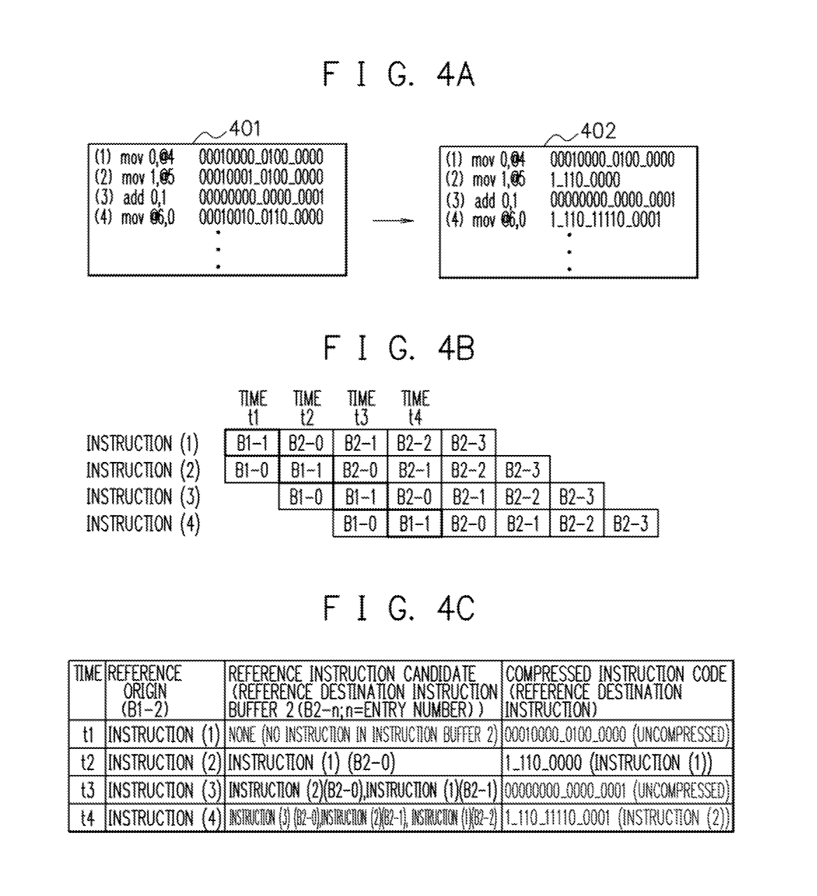

FIG. 4A to FIG. 4C are tables representing a concrete method of generating the compressed instruction code of FIG. 3G. FIG. 4A represents an instruction code 401 before compression and an instruction code 402 after compression for the same instructions (1) to (4) as FIG. 3G. FIG. 4B represents temporal transition of the first instruction buffer 102 and the second instruction buffer 104 with regard to the instructions (1) to (4). Here, a buffer B1-n indicates an entry number n of the first instruction buffer 102, while a buffer B2-n indicates an entry number n of the second instruction buffer 104. FIG. 4C represents compression processings of the instructions (1) to (4) of respective times.

Since the compressed instructions (1) to (4) are fetched from the instruction memory 101 by the first instruction buffer 102 in order and sequentially sent to the second instruction buffer 104 as illustrated in FIG. 1, such a sequence is followed also in a generation process of the compressed instruction code.

At a time t1, the instruction (1) is stored in an entry number 1 (B1-1) of the first instruction buffer 102, and the instruction (2) is stored in an entry number 0 (B1-0) of the first instruction buffer 102, and on this occasion, no instruction is stored in the second instruction buffer 104 yet. At the time t1, since the second instruction buffer 104 is empty, an instruction which the instruction (1) can refer to does not exist, and thus an instruction code 402 after compression is not changed from an uncompressed instruction code.

At a time t2, since the instruction (2) is stored in the entry number 1 (B1-1) of the first instruction buffer 102 and the instruction (1) is stored in an entry number 0 (B2-0) of the second instruction buffer 104, it is possible to make the instruction (1) be a reference instruction candidate for the instruction (2). Since a compressed instruction code in a case that the instruction (1) is used as a reference instruction code can be made compressed based on the instruction code before compression, an instruction code after compression is generated by using the instruction (1) as the reference instruction code. A method of compressing the instruction (2) is the same as that of FIG. 3G.

At a time t3, since the instruction (3) is stored in the entry number 1 (B1-1) of the first instruction buffer 102 and the instruction (1) and the instruction (2) enter the second instruction buffer 104, it is possible to make the instruction (2) and the instruction (1) be reference instruction candidates for the instruction (3). An instruction code after compression using such reference instruction candidates has a larger bit number than the instruction code before compression has, and thus the original instruction code is adopted without compression as a compressed instruction code.

At a time t4, since the instruction (4) is stored in the entry number 1 (B1-1) of the first instruction buffer 102 and the instruction (1), the instruction (2), and the instruction (3) enter the second instruction buffer 104, it is possible to make the instruction (3), the instruction (2), and the instruction (1) be reference instruction candidates for the instruction (4). A compression rate of the instruction (4) becomes the highest when the instruction (2) is used as the reference instruction code, and thus the instruction (4) is compressed with the instruction (2) being used as the reference instruction code. A method of compressing the instruction (4) is the same as that of FIG. 3G.

Thereafter, generation of the compressed instruction code can be performed while an operation of hardware of FIG. 1 is sequentially followed as above.

Next, an operation of the compressed instruction processing device of FIG. 1 will be described. The instruction memory 101 stores a compressed instruction code and an uncompressed instruction code. The first instruction buffer 102 buffers the instruction code S111 having been read out from the instruction memory 101 and outputs the instruction code S112. The compressed instruction expanding circuit 103 refers to the reference instruction code S114, expands the compressed instruction code S112, and outputs the expanded instruction code S113.

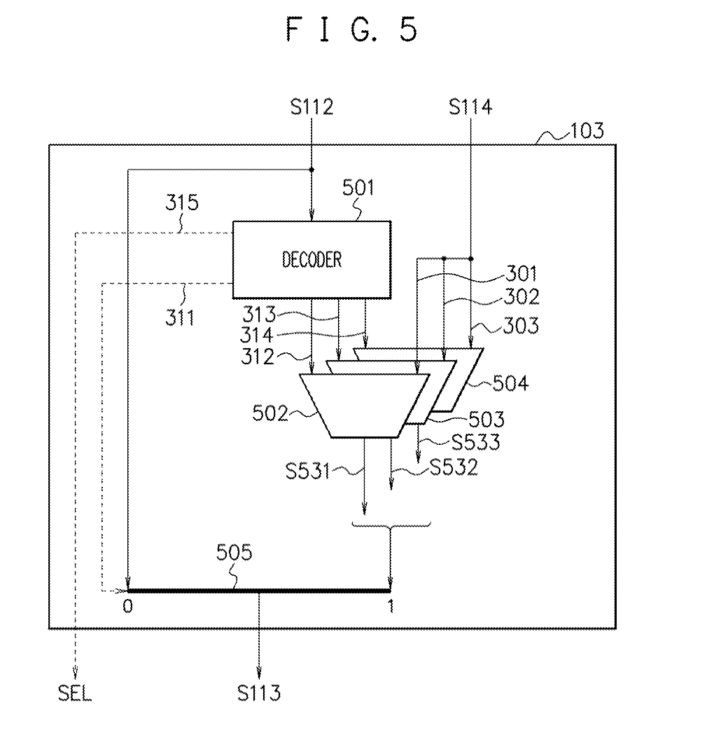

FIG. 5 is a diagram illustrating a constitutional example of the compressed instruction expanding circuit 103. A decoder 501 decodes the respective fields of FIG. 3C of the instruction code S112, and outputs the compressed instruction identification bit 311, the opecode difference code 312, the first operand difference code 313, the second operand difference code 314, and the instruction buffer entry number code 315.

The instruction buffer entry number code 315 is outputted to the selector 105 of FIG. 1 as the selection signal SEL. In FIG. 1, the selector 105 outputs the instruction code S114 stored in the entry number of the second instruction buffer 104, the entry number being indicated by the selection signal SEL, to the compressed instruction expanding circuit 103.

As illustrated in FIG. 5, the reference instruction code S114 is separated to an opecode 301, a first operand 302, and a second operand 303. An adder 502 adds the opecode 301 of the reference instruction code S114 and the opedcode difference code 312 of the compressed instruction code S112, and outputs an opecode S531 after expansion. An adder 503 adds the first operand 302 of the reference instruction code 114 and the first operand difference code 313 of the compressed instruction code S112, and outputs a first operand 5532 after expansion. An adder 504 adds the second operand 303 of the reference instruction code S114 and the second operand difference code 314 of the compressed instruction code S112, and outputs a second operand S533 after expansion. When the compressed instruction identification bit 311 of the inputted instruction code S112 is “1”, a selector 505 outputs the opecode S531, the first operand 5532, and the second operand 5533 as the instruction code S113 after expansion. The instruction code S113 after expansion is the same as the instruction code before compression. Further, when the compressed instruction identification bit 311 of the inputted instruction code S112 is “0”, which indicates that the instruction code S112 is an uncompressed instruction code, the selector 505 outputs the inputted uncompressed instruction code S112 without change as the instruction code S113.

In FIG. 1, when an instruction to be executed next is an asynchronous handling, the execution section 109 outputs an asynchronous handling signal S117 of “1” in order to process the instruction generated asynchronously, and when an instruction to be executed is a synchronous handling, the execution section 109 outputs an asynchronous handling signal S117 of “0” in order to process the instruction having been fetched in the second instruction buffer 104. The asynchronous handlings are, for example, an interrupt handling, a trap handling, an exception handling, a conditional branch handling and the like, and since the instruction occurs asynchronously, an instruction to be executed next cannot be expected, so that the execution section 109 clears the instruction code in the second instruction buffer 104. Further, for such a reason, with regard to the asynchronous handling, an instruction code is stored in the instruction memory 101 without being compressed. In other words, in a case of the asynchronous handling, the compressed instruction identification bit 311 of FIG. 3C becomes 0 and the uncompressed instruction code is stored in the instruction memory 101. In the case of the asynchronous handling, the execution section 109 outputs an asynchronous handling signal S117 of “1”, and the selector 107 selects the instruction code S113 and outputs the instruction code S116 to the execution section 109.

The inverter 108 performs logical inversion on the asynchronous handling signal S117 and outputs the write enable signal WE. When the write enable signal WE is “1” the instruction code S113 is written into the second instruction buffer 104, and when the write enable signal WE is “0” the instruction code S113 is not written into the second instruction buffer 104. In other words, when the asynchronous handling signal S117 is “0” the write enable signal WE becomes “1”, and the instruction code S113 is written into the second instruction buffer 104. When an instruction to be executed next is an asynchronous handling, the execution section 109 makes the asynchronous handling signal S117 be “1” thereby to prohibit a processing of writing the instruction code S113 into the second instruction buffer 104. The selector 106 selects the instruction code to be executed next which has been fetched by the second instruction buffer 104, and outputs the instruction code S116. When the asynchronous handling signal S117 is “0” the selector 107 selects the instruction code S115, and when the asynchronous handling signal S117 is “1” the selector 107 selects the instruction code S113, thereby to output the instruction code S116 to the execution section 109. The execution section 109 executes the inputted instruction code S116, and when an instruction to be executed next is an asynchronous handling the execution section 109 outputs the asynchronous handling signal S117 of “1”, and when an instruction to be executed next is a synchronous handling the execution section 109 outputs the asynchronous handling signal of “0”.

### Second Embodiment

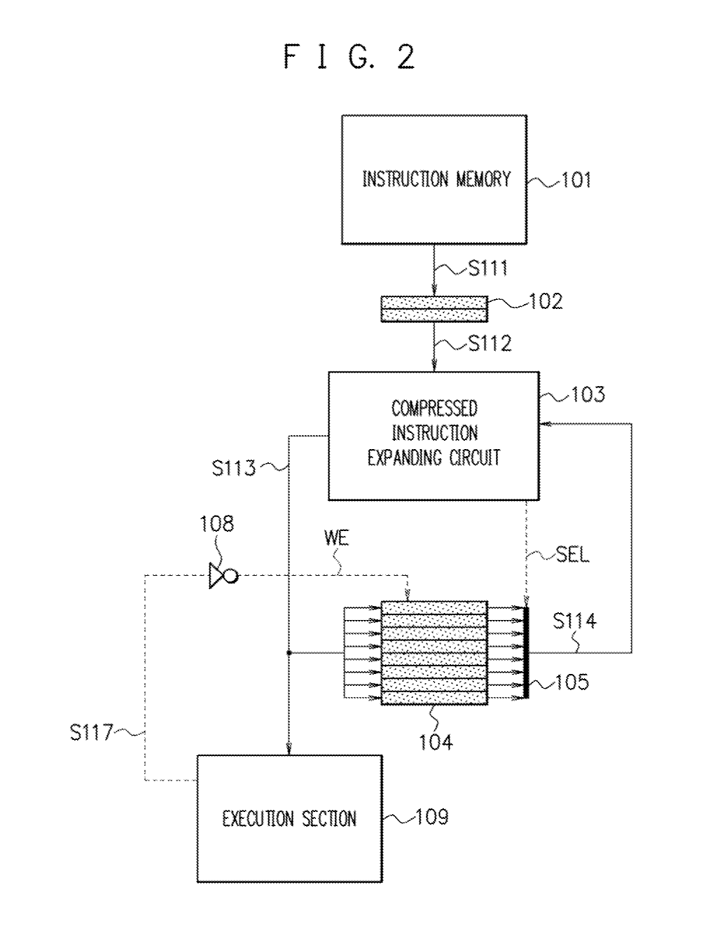

FIG. 2 is a diagram illustrating a constitutional example of a compressed instruction processing device according to a second embodiment. The present embodiment (FIG. 2) is different from the first embodiment (FIG. 1) in a path of an instruction code S113 which a compressed instruction expanding circuit 103 outputs. Hereinafter, points in which the present embodiment is different from the first embodiment will be described. An execution section 109 executes the instruction code S113 regardless of an asynchronous handling signal S117, and outputs the asynchronous handling signal S117. When a write enable signal WE is “1”, the instruction code S113 is written into a second instruction buffer 104.

In the present embodiment, the execution section 109 directly inputs and executes the instruction code S113 of the compressed instruction expanding circuit 103 without intervention of the second instruction buffer 104. Thus, an opportunity in which a content of the second instruction buffer 104 is updated can be considered variously. For example, it is possible to overwrite the instruction code S113 on an entry of an instruction code which is least referred to in the second instruction buffer 104, at a timing when the instruction code is executed. Further, it is possible to make every compressed instruction code S111 include an entry number of the second instruction buffer 104 into which writing is to be done and to write each instruction code S113 into that entry number. When the asynchronous handling signal S117 is “1”, the content of the second instruction buffer 104 is held similarly to in the first embodiment.

The present embodiment, in which the number of instruction buffer stages in a path between the instruction memory 101 and the execution section 109 is small in relation to the first embodiment, is disadvantageous in a system in which an access latency of an instruction memory 101 exists. However, the present embodiment has higher selection flexibility of an instruction to refer to, compared with the first embodiment in which an instruction able to be referred to in the second instruction buffer 104 strongly depends on an execution sequence of instructions, and thus a high compression rate can be expected.

In both the first embodiment and the second embodiment, a compiler needs to take in consideration that an execution instruction order changes by a branch instruction. In the second embodiment, except in a case of explicitly updating the second instruction buffer 104 by a write entry number in an instruction, it is necessary to prohibit referring to an instruction beyond an instruction of a branch destination or of a branch origin in a storing order of an instruction sequence of a program, unless an execution order of instructions such as a loop and an unconditional jump can be assured. Even in a case of explicitly updating by the write entry number in the instruction, in a stage where the compiler generates a compressed instruction code, it is necessary to accurately predict an instruction code to be stored in the second instruction buffer 104 at a time that a compressed instruction code is expanded while being conscious of a change of the execution sequence by the branch instruction.

In the first embodiment, since the second instruction buffer 104 is a FIFO (first in, first out) buffer, instructions older in terms a storing order are sequentially deleted (overwritten) if the instruction number stored in the second instruction buffer 104 exceeds the entry number of the second instruction buffer 104. In contrast, the second embodiment is not limited to the above, and it is possible to improve a compression rate, for example, by taking a history of which instruction has been referred to, and then adopting algorithm to delete (overwrite) instructions old in a reference order (referred to at the earliest time) in sequence or overwriting an arbitrary entry, and so on.

### Third Embodiment

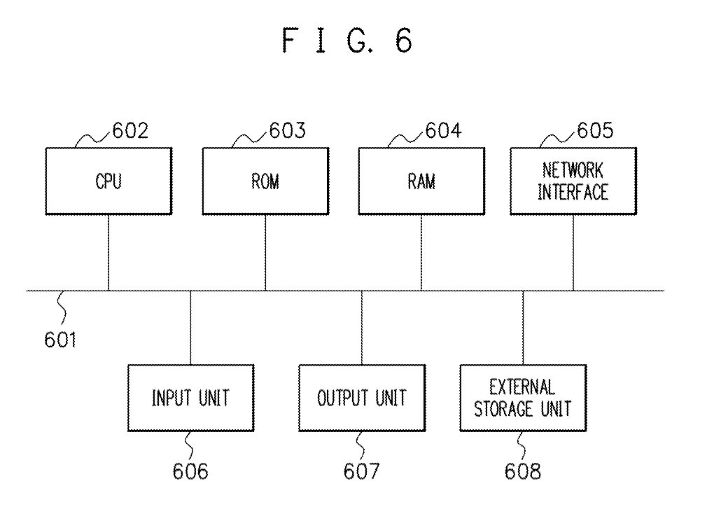

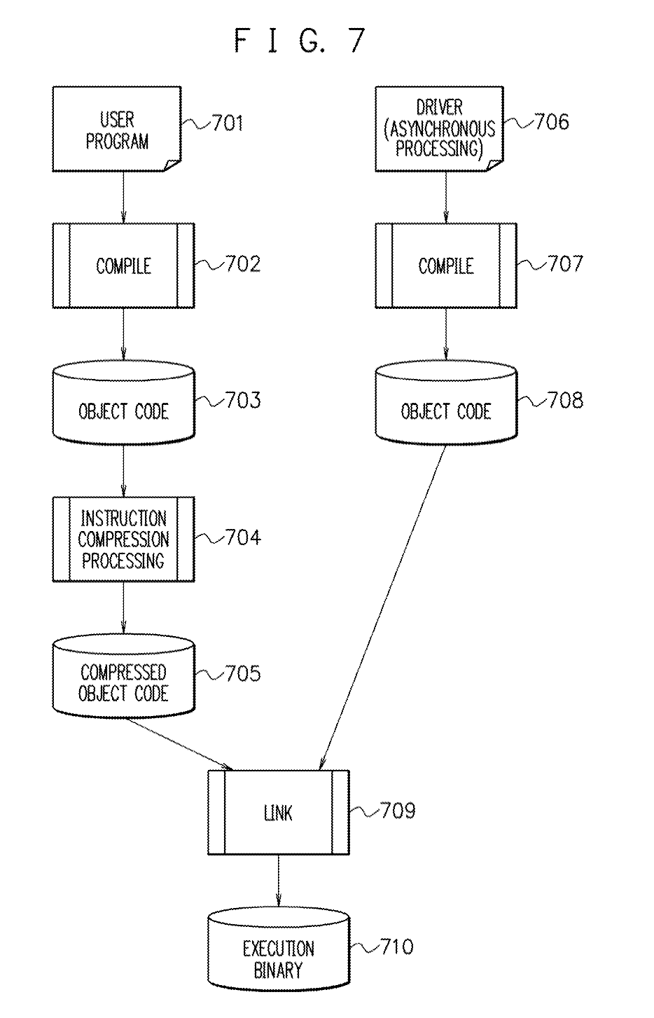

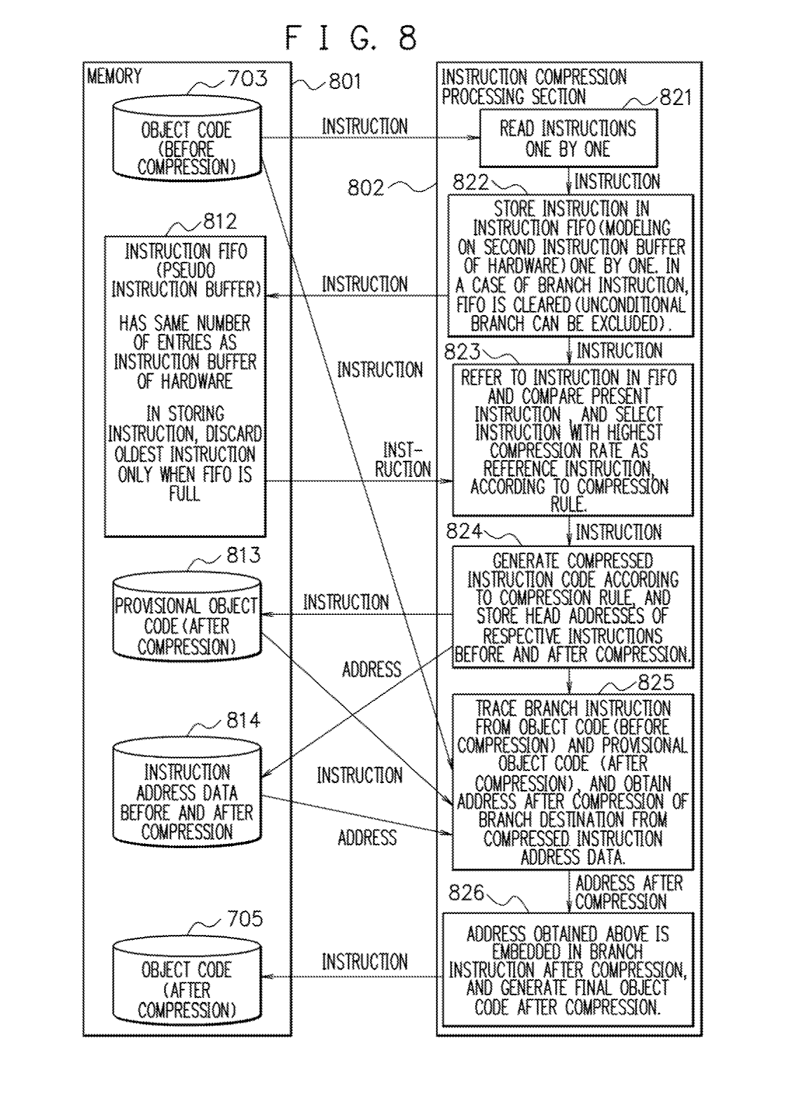

FIG. 6 is a diagram illustrating a hardware constitutional example of a compressed instruction generation device according to a third embodiment. The compressed instruction generation device is, for example, a personal computer (PC), and generates the above-described compressed instruction code. A bus 601 is connected to a central processing unit (CPU) 602, a ROM 603, a RAM 604, a network interface 605, an input unit 606, an output unit 607, and an external storage unit 608. The CPU 602 performs a processing or a computation of data and controls each component connected via the bus 601. A control sequence (computer program) of the CPU 602 is stored in the ROM 603 in advance and the CPU 602 executes this computer program, whereby activation is done. The computer program is stored in the external storage unit 608, and the computer program is copied to the RAM 604 and executed by the CPU 602. The RAM 604 is used as a work memory for input/output and transmission/reception of data and as a temporary memory for control of each component. The external storage unit 608 is, for example, a hard disk storage unit, a CD-ROM or the like, in which a storage content does not disappear even when a power supply is turned off. The CPU 602 performs processings of FIG. 7 and FIG. 8 which will be described later by executing the computer program in the RAM 604. The network interface 605 is an interface for connecting to a network such as Internet. The input unit 606 is, for example, a keyboard, a mouse and the like, and various designation, an input or the like can be done thereby. The output unit 607 is a display, a printer and the like.

The present embodiment can be realized by the computer's executing the program. Further, a computer program product such as a computer readable storage medium in which the above-described program is stored and the above-described program can be applied as an embodiment. As the storage medium, for example, a flexible disk, a hard disk, an optical disk, a magnetic optical disk, a CD-ROM, a magnetic tape, a nonvolatile memory card, and a ROM can be used.

FIG. 7 is a flowchart illustrating a method of generating a compressed instruction code by the compressed instruction generation device of FIG. 6. An instruction-compression object is a user program 701. The user program 701 is a high-level language program to be executed by the compressed instruction processing device of FIG. 1 or FIG. 2. In a step 702, a compiler compiles the high-level language user program 701 thereby to generate a machine-language object code (instruction code) 703. The compiler is realized as a result that the compressed instruction generation device of FIG. 6 executes a program of the compiler. In a step 704, an instruction compression processing section compresses an object code 703 thereby to generate a compressed object code (compressed instruction code) 705. Details thereof will be explained later with reference to FIG. 8. The instruction compression processing section is realized as a result that the compressed instruction generation device of FIG. 6 executes a program of the instruction compression processing section. For example, the instruction compression processing section compresses an instruction code 321 of FIG. 3G thereby to generate an instruction code 322.

In contrast, an instruction of an asynchronous handling such as an interruption handling or an exception handling is prepared as a driver 706. The driver 706 is not subject to instruction compression. In a step 707, the compiler compiles the high-level language driver 706 thereby to generate a machine-language uncompressed object code (instruction code) 708.

In a step 709, a linker links the compression object code 705 and the object code 708 thereby to generate an execution binary code (instruction code) 710. The linker is realized as a result that the compressed instruction generation device of FIG. 6 executes a program of the linker. The execution binary code 710 is stored in a instruction memory 101 of FIG. 1 or FIG. 2, and the above-described processing is performed by a compressed instruction processing device of FIG. 1 or FIG. 2.

FIG. 8 is a flowchart illustrating a processing of the instruction compression processing section of the step 704 of FIG. 7. An instruction compression processing section 802 represents processings of the program of the instruction compression processing section executed by the compressed instruction generation device (personal computer) of FIG. 6. A memory 801 corresponds to the RAM 604 and/or the external storage unit 608 of FIG. 6, and various storage regions used in the instruction compression processing section 802 are prepared.

The object code 703 is the object code (instruction code being a compression object) 703 before compression of FIG. 7, and is stored in the memory 801. In a step 821, the instruction compression processing section 802 sequentially reads instruction codes one by one from the object codes 703 of an instruction code column. Next, in a step 822, a storage part of the instruction compression processing section 802 sequentially stores instructions having been read one by one in an instruction FIFO 812 on the memory 801. The instruction FIFO 812 models on a second instruction buffer 104 of hardware of FIG. 1 or FIG. 2, and only the instruction stored in the instruction FIFO 812 can be a candidate of a reference instruction code S114. The instruction FIFO 812 has a plurality of entries to store a plurality of instruction codes. The instruction FIFO 812 has the same number of entries as the second instruction buffer 104, and only in a case of being full at an instruction storage time, the oldest instruction code is discarded. It should be noted that the instruction compression processing section 802 clears a content of the instruction FIFO 812 if an instruction being a compression object is a branch instruction, similarly to in a compression instruction processing device of FIG. 1 or FIG. 2. However, in a case of unconditional branch, the above is not necessarily applied.

Next, in a step 823, a selection part of the instruction compression processing section 802 compares the present instruction code having been read in the above and an instruction code in the instruction FIFO 812, and selects the instruction code of the highest compression rate in the instruction FIFO 812 as the reference instruction code S114 in accordance with a compression (encoding) rule of FIG. 3A to FIG. 3G. In other words, the selection part selects one of the instruction codes in the instruction FIFO 812 as the reference instruction code S114 in order to compress an instruction code being a compression object.

Next, in a step 824, a generation part of the instruction compression processing section 802 compresses the above-described present instruction code having been read based on the selected reference instruction code S114 according to the compression rule of FIG. 3A to FIG. 3G, generates a compressed instruction code as a provisional object code 813, and once stores the compressed instruction code in the memory 801. The provisional object code 813 is a compressed instruction code, has a format of FIG. 3C, and includes a difference code between the present instruction code being the compression object and the reference instruction code S114. Simultaneously, since a storage part of the instruction compression processing section 802 knows an address of the instruction code before compression and an address of the instruction code after compression, the storage part of the instruction compression processing section 802, for enabling the address (head address) of the instruction code after compression to be retrieved by the address (head address) of the instruction code before compression, stores both addresses (head addresses) in the memory 801 as instruction address data 814 before and after compression. The instruction address data 814 before and after compression is data having a correspondence between the address of the instruction code (compression object) before compression and the address of the instruction code (compressed instruction code) after compression.

Next, in a step 825, an acquisition part of the instruction compression processing section 802, after once compressing all the object codes as above, traces the branch instruction from heads of the object code 703 before compression and the provisional object code 813 after compression. On this occasion, a branch destination address of the branch instruction having been traced is the address of the object code in a state of still before compression. The instruction compression processing section 802 refers to the instruction address data 814 before and after compression and obtains a branch destination address of the instruction code after compression from the branch destination address of the instruction code before compression.

Next, in a step 826, a conversion part of the instruction compression processing section 802 converts the branch destination address of the branch instruction, when the instruction after compression is the branch instruction, from the address of the instruction code before compression to the address of the instruction code after compression, thereby generates the final object code 705 after compression.

As stated above, according to the first to third embodiments, storing the compressed instruction code in the instruction memory (cache memory) 101 contributes to reduction of the content capacity of the instruction memory 101 and improvement of a cache hit rate of the instruction memory 101. Further, the compressed instruction processing device of FIG. 1 or FIG. 2 does not need a reference table or a dictionary table for large address conversion, and thus the circuit scale can be made smaller.

By compressing an instruction, a program memory capacity can be reduced. Further, a compressed instruction can be expanded by a small circuit scale.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A compressed instruction processing device comprising:
a compressed instruction expanding circuit which expands a compressed instruction code that include a difference code between an instruction code being a compression object and a reference instruction code and which outputs an expanded instruction code;
an instruction buffer storing the instruction code expanded by the compressed instruction expanding circuit; and
an execution section executing the instruction code expanded by the compressed instruction expanding circuit,
wherein the compressed instruction expanding circuit outputs the expanded instruction code by inputting the instruction code in the instruction buffer as the reference instruction code and adding the reference instruction code and the difference code in the compressed instruction code.

2. The compressed instruction processing device according to claim 1,
wherein the instruction buffer has a plurality of entries to store a plurality of instruction codes,
wherein the compressed instruction code includes a number of the entry in the instruction buffer in which the reference instruction code is stored, and
wherein the compressed instruction expanding circuit inputs the reference instruction code from the entry of the instruction buffer indicated by the number of the entry in the compressed instruction code and adds the reference instruction code and the difference code in the compressed instruction code.

3. The compressed instruction processing device according to claim 1,
wherein the compressed instruction code includes the difference code per a field of the instruction code being the compression object, and
the compressed instruction expanding circuit performs the adding per the field.

4. The compressed instruction processing device according to claim 1,
wherein the execution section prohibits a processing to write the instruction code expanded by the compressed instruction expanding circuit into the instruction buffer when an instruction to be executed next is an asynchronous handling.

5. The compressed instruction processing device according to claim 1,
wherein the compressed instruction code includes compressed instruction identification information indicating that an instruction code is compressed, and
wherein the compressed instruction expanding circuit outputs the expanded instruction code when the compressed instruction identification information exists in an inputted instruction code, and outputs the inputted uncompressed instruction code without change when the compressed instruction identification information does not exist in an inputted instruction code.

6. The compressed instruction processing device according to claim 1,
wherein the execution section executes the instruction code expanded by the compressed instruction expanding circuit via the instruction buffer.

7. The compressed instruction processing device according to claim 1,
wherein the execution section executes the instruction code expanded by the compressed instruction expanding circuit without intervention of the instruction buffer.

8. A compressed instruction generation device comprising:
an instruction FIFO to store an instruction code;
a selection part which sequentially stores an instruction code being a compression object in the instruction FIFO and selects one of the instruction codes in the instruction FIFO as a reference instruction code in order to compress the instruction code being the compression object; and
a generation part generating a compressed instruction code which includes information of a difference between the instruction code being the compression object and the reference instruction code selected by the selection part.

9. The compressed instruction generation device according to claim 8, further comprising:
a conversion part which stores a correspondence between an address of the instruction code being the compression object and an address of the compressed instruction code, and when the compressed instruction code is of a branch instruction, converts a branch destination address of the branch instruction from the address of the instruction code of the compression object into the address of the compressed instruction code.

10. The compressed instruction generation device according to claim 8,
wherein the instruction FIFO has a plurality of entries to store a plurality of instruction codes, and
wherein the generation part generates the compressed instruction code which includes the number of the entry in the instruction FIFO in which the reference instruction code is stored.
